(19) United States
(12) Patent Application Publication
(10) Pub. No.: US 2025/0299309 A1
(43) Pub. Date: Sep. 25, 2025

(54) SIGNAL PROCESSING DEVICE, SIGNAL PROCESSING METHOD, AND STORAGE MEDIUM

(71) Applicant: CANON KABUSHIKI KAISHA, Tokyo (JP)

(72) Inventors: KOHEI SATO, Tokyo (JP); KEISUKE MATSUNO, Kanagawa (JP); JUN WATANABE, Kanagawa (JP)

(21) Appl. No.: 19/068,729

(22) Filed: Mar. 3, 2025

(30) Foreign Application Priority Data
Mar. 22, 2024 (JP) 2024-047085

(51) Int. Cl. G06T 5/92

(52) U.S. Cl. CPC G06T 5/92; G06T 2207/20092

(57) ABSTRACT

A signal processing device has a storage unit configured to hold data for a tone curve to be applied to an input image; a correction parameter acquisition unit configured to acquire a high-luminance side gradation correction parameter for adjusting a correction amount of a high-luminance side gradation correction for the tone curve; a correction amount calculating unit configured to calculate the correction amount for the high-luminance side gradation correction such that a dynamic range of the tone curve is maintained based on a maximum output level for the tone curve and the high-luminance side gradation correction parameter; a correction curve generating unit configured to generate a correction curve by applying the high-luminance side gradation correction to the tone curve; and a correction curve application unit configured to apply the correction curve to the input image.

### BACKGROUND OF THE DISCLOSURE

### Field of the Disclosure

One disclosed aspect of the embodiments relates to a signal processing device, a signal processing method, a storage medium, and the like.

### Description of the Related Art

Knee correction is generally used in order to correct high-luminance side gradation in images. Knee correction is processing that suppresses an output level by changing the slope (knee slope) of the high-luminance portions that have an output level (knee point) of a predetermined level or greater. The user is able to perform adjustments to an image by changing the position of a knee point and the extent of the knee slope.

However, if the settings for the position of the knee point, and the knee slope are not appropriate, there are cases in which the dynamic range of the input signal is unintentionally lowered, and in which this becomes less than the desired output signal level. In this case, the dynamic range for the input signal cannot be fully utilized, and the signal level is unintentionally clipped on the display device side, and there are cases in which color curving occurs on the high-luminance side.

Japanese Unexamined Patent Application, First Publication No. 2016-076908, gradation correction is performed based on a control point and a histogram that have been set by a user. In Japanese Unexamined Patent Application, First Publication No. 2006-254415, a representative luminance value of a specific range that is inside of an image is calculated and a target representative value and a target dynamic range are set in relation to this. The target bright luminance value and the target dark luminance value are calculated, and luminance conversion is performed from these values that have been set.

### SUMMARY OF THE DISCLOSURE

According to a first aspect of the embodiments there is provided a signal processing device comprising at least one processor or circuit configured to function as: a storage unit configured to hold data for a tone curve to be applied to an input image; a correction parameter acquisition unit configured to acquire a high-luminance side gradation correction parameter for adjusting a correction amount of a high-luminance side gradation correction for the tone curve; a correction amount calculating unit configured to calculate the correction amount for the high-luminance side gradation correction such that a dynamic range of the tone curve is maintained based on a maximum output level for the tone curve and the high-luminance side gradation correction parameter; a correction curve generating unit configured to generate a correction curve by applying the high-luminance side gradation correction to the tone curve; and a correction curve application unit configured to apply the correction curve to the input image.

Further features of the disclosure will become apparent from the following description of embodiments with reference to the attached drawings.

### BRIEF DESCRIPTION OF THE DRAWINGS

FIG. 1 is a functional block diagram showing an internal configurational example of an image capturing apparatus according to a First Embodiment.

FIG. 2 is a functional block diagram showing a configurational example of a knee correction processing unit 200 inside of an image processing unit 112 according to the First Embodiment,

FIG. 3 is a flowchart showing a processing example of the knee correction processing unit 200 in a signal processing method according to the First Embodiment.

FIG. 4 is a diagram showing an example of a knee point setting method according to the First Embodiment.

FIG. 5 is a diagram showing an example of a knee slope generating method according to the First Embodiment.

FIG. 6 is a diagram showing an example of a setting method according to a user for the knee point and the knee slope according to the First Embodiment,

FIG. 7 is a diagram showing an example of a message that notifies a user that the knee slope will be set according to the maximum output level according to the First Embodiment.

FIG. 8 is a flowchart showing a processing example in a signal processing method according to a Second Embodiment.

FIG. 9 is a diagram showing an example of a knee slope setting method according to the Second Embodiment.

FIG. 10 is a diagram showing an example of a message that notifies a user that the knee point value will be set according to the maximum output level according to the Second Embodiment.

### DESCRIPTION OF THE EMBODIMENTS

Hereinafter, embodiments will be described in detail with reference to the attached drawings. Note that the following embodiments are not intended to limit the scope of the claimed disclosure, and limitation is not made to a disclosure that requires a combination of all features described in the embodiments. Two or more of the multiple features described in the embodiments may be combined as appropriate. Furthermore, the same reference numerals are given to the same or similar configurations, and redundant descriptions thereof are omitted.

### First Embodiment

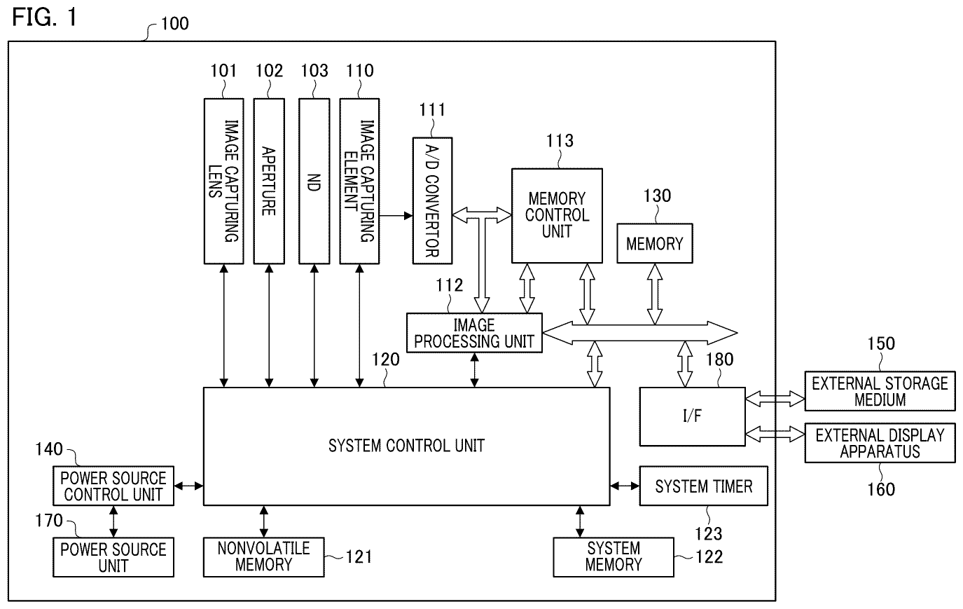

FIG. 1 is a functional block diagram showing an internal configurational example of an image capturing apparatus according to the First Embodiment, Note that a portion of the functional blocks that are shown in FIG. 1 are realized by a CPU and the like that is not shown, and that serves as a computer that is included in the image capturing apparatus, executing a computer program that has been stored on a memory that is also not shown and that serves as a storage medium.

However, a portion or the entirety thereof may also be made so as to be realized by hardware. As the hardware, an application-specific integrated circuit (ASIC), a processor (a reconfigurable processor, a DSP), and the like can be used.

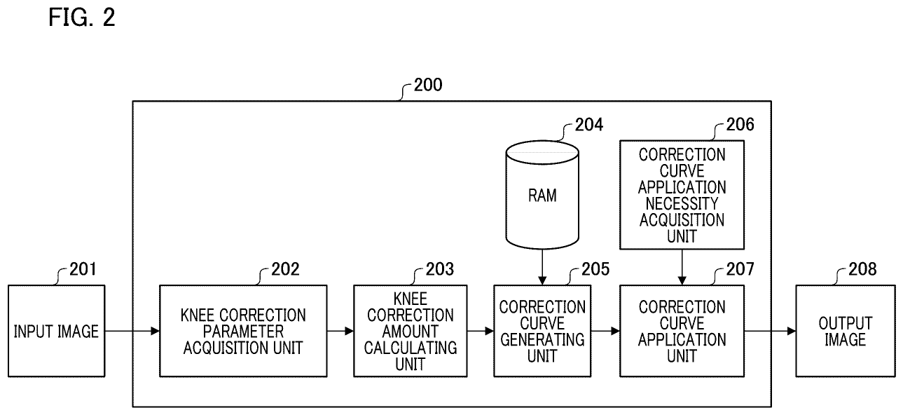

In addition, each of the functional blocks that are shown in FIG. 1 do not need to be housed in the same body, and may also be configured by separate apparatuses that have been connected to each other via signal paths. The above explanation in relation to FIG. 1 also applies to FIG. 2.

Note that although the image capturing apparatus according to the Present Embodiment functions as a signal processing device, the signal processing device may also be configured separately from the image capturing apparatus, and may also be made so as to perform the signal processing method according to the Present Embodiment by using an external apparatus such as, for example, a PC and the like that has been connected to the image capturing apparatus.

An image capturing apparatus 100 has an image capturing lens 101, an aperture 102, an ND filter 103, an image capturing element 110, an A/D converter 111, an image processing unit 112, a memory control unit 113, and a system control unit 120. The image capturing apparatus further has a non-volatile memory 121, a system memory 122, a system timer 123, a memory 130, a power source control unit 140, a power source unit 170, and an I/F 180.

The image capturing lens 101 is a lens group comprising a zoom lens, a focus lens, and a shift lens, and forms a subject image. The aperture 102 is an aperture that is used in light quantity adjustment. The ND filter 103 is a neutral density filter.

The image capturing element 110 is for example, a CMOS image sensor, and is also provided with functions such as controlling accumulation due to an electronic shutter, changing the gain, changing the read-out speed, and the like. The A/D converter 111 is used in order to convert the analogue signal that is output from the image capturing element 110 into a digital signal.

The image processing unit 112 performs image processing on image data from the A/D converter 111 and the memory control unit 113. Image processing includes, for example, predetermined pixel interpolation processing, resizing processing such as compression processing, image rotation and geometric deformation, cutting out images, detection processing such as detection of luminance information, color information, a feature subject, and the like, color conversion processing, gamma correction processing, digital gain addition processing, and the like.

Gamma correction processing includes knee correction that corrects high-luminance side gradation by changing the position of the knee point, and the knee slope (a value showing the inclination of the knee curve (knee line)). The image processing in the image processing unit 112 includes image processing by a dedicated arithmetic circuit, image processing by a 3D-LUT processing circuit, and the like. In addition, the image processing unit 112 performs predetermined arithmetic processing by using image data from the image capturing element 110, and transmits the arithmetic results to the system control unit 120.

In addition, the system control unit 120 performs exposure control, ranging control, white balance control, and the like based on the arithmetic results that have been sent. AF (autofocus) processing using a TTL (through the lens) format, AE (auto-exposure) processing, AWB (auto-white balance) processing, and the like are thereby performed.

The output data from the A/D converter 111 are written onto the memory via the image processing unit 112 and the memory control unit 113, or via the memory control unit 113. The memory 130 stores image data from the image capturing element 110 and the image processing unit 112.

In addition, the memory 130 temporarily stores images that have been image processed by the image processing unit 112, and is also used in order to once again return images to the image processing unit 112 and apply different image processing to these images. The memory 130 is provided with a sufficient storage amount for storing moving images and audio for a predetermined time period.

The non-volatile memory 121 is an electrically erasable and storable memory, and uses, for example, EEPROM. The non-volatile memory 121 stores constants, programs, and the like for use in the operations of the system control unit 120. In this context, programs indicate computer programs for executing each type of flowchart to be explained below.

The system control unit 120 functions as a control unit for controlling the image capturing apparatus 100. The system control unit 120 includes a CPU that serves as a computer and that is not shown, and each processing to be explained below for the Present Embodiment is executed by this CPU executing a computer program that has been stored on the non-volatile memory 121 that was described above.

The system memory 122 uses a RAM, and expands the constants, variables, and programs that have been read out from the non-volatile memory 121 and the like for use in the operations of the system control unit 120. The system timer 123 is a timing unit that calculates time that is used in each type of control, and time for a clock that is housed in the system timer 123.

The power source control unit 140 is configured by a battery detecting circuit, a DC-DC converter, a switching circuit that switches between blocking the flow of an electric current, and the like, and performs the detection of the presence or absence of a battery that has been installed, the type of the battery, and the remaining amount for the battery. In addition, the power source control unit 140 controls the DC-DC converter and provides the necessary voltage for the necessary period of time to each unit including an external storage medium 150 based on these detection results and a command from the system control unit 120.

The power source unit 170 comprises a primary battery, such as an alkali battery, a lithium battery, and the like, a secondary battery such as an Li ion battery, an NiCD battery, an NiMH battery, and the like, an AC adapter, and the like. The I/F 180 is an interface between the external storage medium 150 such as a memory card, a hardware disk, and the like, and an external display apparatus 160. The external storage medium 150 is a storage medium such as a memory card and the like for performing the storage and external data exchanges of images that have been captured, and uses a semi-conductor memory and the like.

FIG. 2 is a functional block diagram that shows a configurational example of a knee correction processing unit 200 inside of the image processing unit 112 according to the First Embodiment. In the First Embodiment, it is made such that the user can adjust the knee correction parameter without referring to the dynamic range for the input signal, and the output signal level by using the knee correction processing unit 200. Note that the purpose of the knee correction in the Present Embodiment is to perform high-luminance side gradation correction for the input signal.

The knee correction processing unit 200 has a knee correction parameter acquisition unit 202, a knee correction amount calculating unit 203, a RAM 204, a correction curve generating unit 205, a correction curve application necessity acquisition unit 206, a correction curve application unit 207, and the like. An input image 201 is an image based on the output signal from the A/D converter 111, and the knee correction processing unit 200 applies knee correction to the input image 201 and outputs an output image 208.

First, the knee correction processing unit 200 acquires a maximum output level and a knee point that have been indicated by the user by using the knee correction parameter acquisition unit 202. Then, the knee correction amount calculating unit 203 calculates the knee slope (value showing the inclination of the knee curve (knee line)) based on the maximum output level and the knee point.

Note that the knee correction parameter acquisition unit 202 acquires the high-luminance side gradation correction parameter in order to adjust the correction amount for the high-luminance side gradation correction for the tone curve. Note that in the Present Embodiment, the high-luminance side gradation correction parameter is the parameter for the knee correction to be applied to the tone curve, and is one of the parameters of knee point where the knee correction begins, or the knee slope.

In addition, the knee correction amount calculating unit 203 calculates the correction amount for the high-luminance side gradation correction such that the dynamic range of the tone curve is maintained based on the maximum output level for the tone curve, and the high-luminance side gradation correction parameter. That is, the knee correction amount calculating unit 203 calculates the knee correction amount such that the dynamic range of the tone curve will be maintained based on the maximum output level, and the knee correction parameter.

The RAM 204 stores the data for the tone curve and functions as a storage unit configured to hold data for the tone curve to be applied to the input image. The correction curve generating unit 205 generates a correction curve by applying knee correction to the data for the tone curve that has been read out from the RAM 204. That is, the correction curve generating unit 205 generates the correction curve by applying high-luminance side gradation correction to the tone curve.

The correction curve application unit 207 applies the correction curve according to the results that have been acquired from the correction curve application necessity acquisition unit 206, and outputs the output image 208. That is, the correction curve application unit 207 applies the correction curve to the input image.

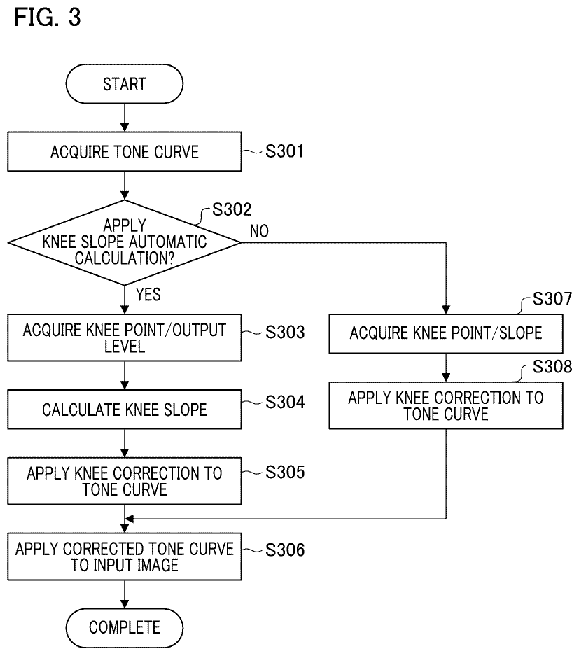

FIG. 3 is a flowchart showing a processing example for the knee correction processing unit 200 in the signal processing method according to the First Embodiment, and shows an example of a processing method for the knee correction processing unit 200. Note that the operations for each step of the flowchart that is shown in FIG. 3 are performed in order by the CPU and the like that serves as a computer inside of the system control unit 120 executing the computer program that has been stored on the memory.

During step S301, the knee correction processing unit 200 acquires the data for the tone curve from the system control unit 120, and expands the data on the RAM 204.

During step S302, the correction curve application necessity acquisition unit 206 determines whether or not to apply knee slope automatic calculations based on a command from the user. That is, the correction curve application necessity acquisition unit 206 determines whether or not there has been a command from the user to apply knee slope automatic calculations. In a case in which yes has been determined, the processing proceeds to step S303. In a case in which no has been determined, the processing proceeds to step S307.

In this context, step S302 functions as a determining step (a determination means) configured to receive and determine whether or not to apply high-luminance side gradation correction of a correction amount that has been calculated by the knee correction amount calculating unit 203. In addition, in a case in which it has been determined by the determining step (determination means) that the high-luminance side gradation correction will be applied, by proceeding to the processing for step S303 and the processing that follows this, the correction curve is applied to an input image.

That is, during step S303, the knee correction parameter acquisition unit 202 acquires the knee point and the output level. That is, the input of the maximum output level for the knee correction, and the knee point is received from the user.

In this context, step S301 and step S303 function as a correction parameter acquisition step configured to acquire a maximum output level of the tone curve that will be applied to the input image and a high-luminance side gradation correction parameter for adjusting the high-luminance side gradation correction level of the tone curve.

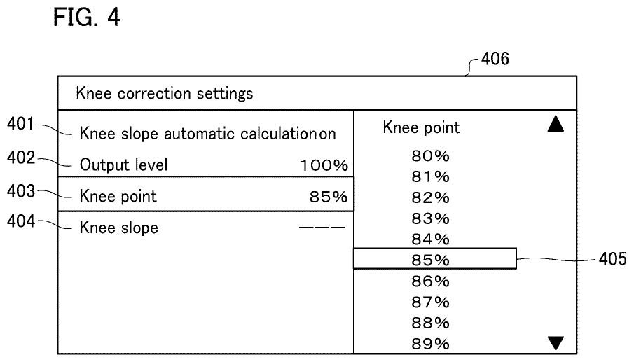

FIG. 4 is a diagram showing an example of a setting method for the knee point according to the First Embodiment, and shows an example of a GUI (graphical user interface) for acquisition by the knee parameter acquisition unit 202 and the setting of the knee correction.

The GUI screen 406 in FIG. 4 has a portion 401 that receives an on/off for the knee slope automatic calculation, a portion 402 that receives an output level (the maximum output level for the knee correction), a portion 403 that receives the knee point, and a portion 404 that receives the knee slope.

In the example in FIG. 4, the portion 401 that receives the on/off for the knee slope automatic calculation is set to on, and during step S302, it is thereby determined that the knee slope automatic calculation will be applied. When it has been determined that the automatic calculation for the knee slope will be applied, it thereby becomes such that the portion 404 that receives the knee slope displays that input from the user cannot be received.

That is, during step S302, in a case in which it has been determined that the automatic calculation for the knee slope will be applied as the knee correction amount, input from the user for the knee slope parameter cannot be received.

By the user aligning the cursor with the portion 403 that receives the knee point in the example in FIG. 4, the setting screen 405 for setting the knee point is displayed, and it is possible to receive a command for the knee point that serves as the adjustment parameter from the user. Note that in FIG. 4, if the cursor is aligned with each of the portions 401 to 404, a setting screen 405 for setting the setting parameter that corresponds to each of these portions is displayed on the right side of the screen.

By using a GUI such as the GUI that is shown in FIG. 4, it is possible for the user to set the output level (the maximum output level for the knee correction), and the knee point, and in step S303, these settings are acquired. During step S304, the knee correction amount calculating unit 203 calculates the knee slope (a value showing the inclination of the knee curve) from the maximum output level, and the knee point that have been received from the user.

In this context, step S304 functions as a correction amount calculating step configured to calculate a correction amount for the high-luminance side gradation correction such that a dynamic range of the tone curve is maintained based on the maximum output level and the high-luminance side gradation correction parameter.

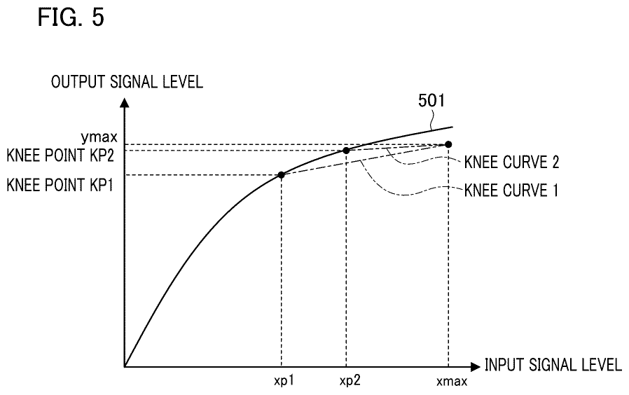

FIG. 5 is a diagram showing an example of a generating method for the knee slope according to the First Embodiment, wherein the vertical axis shows the output signal level, while the horizontal axis shows the input signal level. In FIG. 5, a knee slope ks1 of the knee curve 1 is generated in relation to the tone curve 501 based on a maximum output level ymax and a knee point kp1 that have been received from the user. Note that the maximum input level for the tone curve 501 is made xmax.

If the knee point kp1 is determined, then the input signal xp1 on the knee point kp1 on top of the tone curve 501 is determined. At this time, the knee slope ks1 can be calculated using the following Formula 1.

$$ks 1 = ( ymax - k p 1 ) / ( xmax - xp 1 ) \qquad ( Formula 1 )$$

In the same manner, if the input signal level in the knee point kp2 is made xp2, then the knee slope ks2 for the knee curve 2 can be calculated using the following Formula 2.

$$ks 2 = ( ymax - k p 2 ) / ( xmax - xp 2 ) \qquad ( Formula 2 )$$

In this manner, by determining the parameter for the knee correction, it is possible to generate the knee slope such that the maximum output level ymax that has been set by the user is reached at the maximum input level xmax without the user referring to the maximum input level xmax.

During step S305, the correction curve generating unit 205 generates a correction curve by applying the knee correction to the tone curve 501 based on the knee point that has been received from the user during step S303, and the knee slope that has been calculated during step S304.

That is, until the input signal level reaches the xp1 and xp2 that correspond to the knee point, the tone curve 501 is used, and the correction curve (the corrected tone curve) that uses the knee curve 1 or the knee curve 2 is generated at xp1 and xp2 or above in relation to the knee point. In this context, step S305 functions as a correction curve generating step configured to generate a correction curve by applying the high-luminance side gradation correction to the tone curve.

During step S306, the correction curve application unit 207 applies the correction curve (the corrected tone curve) that has been generated by the correction curve generating unit 205 to the input image 201, and outputs the output image 208. In this context, step S306 functions as a correction curve applying step configured to apply a correction curve to an input image.

In contrast, in a case in which it has been determined that the knee slope automatic calculation will not be applied during step S302, during step S307, the knee correction parameter acquisition unit 202 acquires the knee point for the knee correction that has been set (input) by the user and a knee slope that has been set (input) by the user.

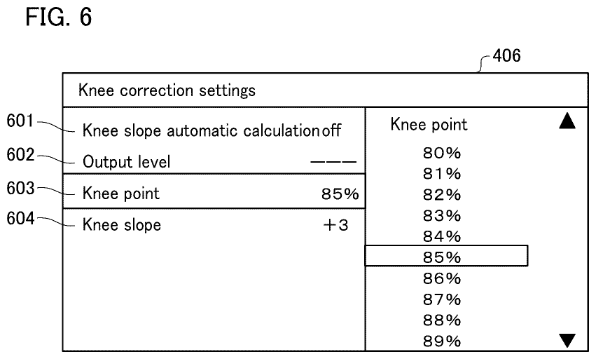

FIG. 6 is a diagram showing an example of a setting method by the user for the knee point and the knee slope according to the First Embodiment. In the GUI screen 406 that is shown in FIG. 6, the portion 601 that receives the on/off for the knee slope automatic calculation is set to off, and it is thereby determined during step S302 that the knee slope automatic calculation correction will not be applied.

By aligning the cursor with each of the items on the left side of the GUI screen 406 and entering the menu, it is possible for the user to perform inputs (settings) such as making the portion 603 that receives the knee point, for example, 85%, and making the portion 604 that receives (the value for the inclination of) the knee slope, for example +3, and the like. At this time, a setting for the portion 602 that receives the output level (the maximum output level for the knee correction) does not need to be received from the user, and therefore, it is displayed that input cannot be received, as is shown in FIG. 6.

Using a GUI such as the GUI that is shown in FIG. 6, it is possible for the user to manually set the knee point and knee slope, and these settings are acquired during step S307.

During step S308, the correction curve generating unit 205 generates the correction curve by applying the knee correction to the tone curve 501 based on the parameters for the knee point and the knee slope that have been received from the user during step S307.

That is, during step S308, in a case in which it has been determined during step S302 that the calculation of the knee correction amount by the correction amount calculating unit will not be applied, the correction curve is generated according to the parameters for the knee slope and the knee point that were input by the user.

Specifically, the tone curve 501 is used until the input signal level reaches the value corresponding to the knee point that has been indicated by the user, and after this, the correction curve that will become the knee slope that uses the knee slope that has been indicated by the user (the corrected tone curve) is generated.

In addition, during step S306, the correction curve application unit 207 applies the correction curve (the corrected tone curve) that has been generated by the correction curve generating unit 205 to the input image 201 and thereby outputs the output image 208.

As has been described above, according to the Present Embodiment, it is possible to adjust the appropriate parameters for knee correction without the user taking into considering the dynamic range for the input signal and the output signal level.

Note that in the Present Embodiment, although an example has been explained of the operations for a case in which the maximum output level for the knee correction is received from the user by the knee correction parameter acquisition unit 202, it may also be made such that a predetermined maximum output level is stored on the RAM 204.

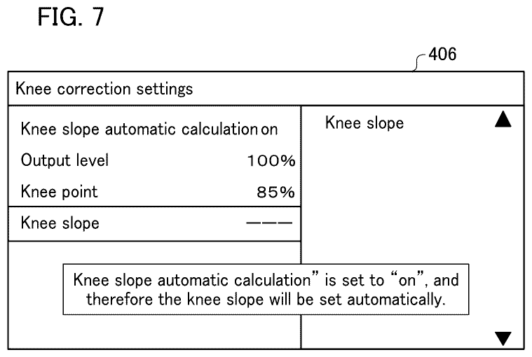

In addition, in the example that has been shown in FIG. 4, although an example has been explained of a GUI that makes it such that settings for the knee slope cannot be received from the user in a case in which the knee slope automatic calculation is on, as is shown in FIG. 7, a text such as, for example “the knee slope will be automatically set” may also be displayed. Conversely, as is shown in FIG. 7, it may also be displayed that “knee slope automatic calculation is on”.

In this manner, a message may also be displayed that shows that the parameter for the knee slope will be automatically calculated in a case in which the calculation for the knee slope correction amount by the correction amount calculating unit will be applied.

In this manner, according to the Present Embodiment, it is possible to realize a signal processing device that is able to adjust the parameters for knee correction without the user referencing the dynamic range for the input signal, and the output signal level.

### Second Embodiment

Next, the Second Embodiment of the present disclosure will be explained. Note that the explanations of configurational portions that are the same as the configurations in the First Embodiment will be omitted. In the Second Embodiment, the operations for a case in which the knee point level is calculated from the maximum output level and the knee slope will be explained.

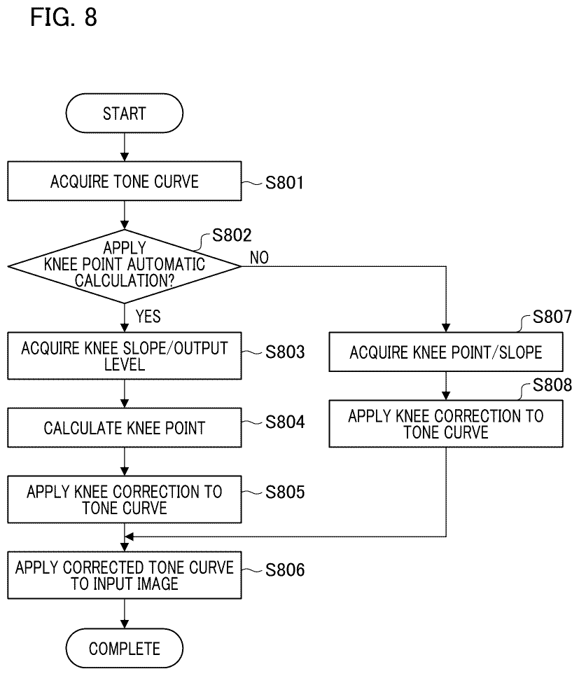

FIG. 8 is a flowchart showing a processing example for a signal processing method according to the Second Embodiment, and shows an example of the processing method for a knee correction processing unit 200. Note that the processes for each step of the flowchart in FIG. 8 are performed in order by the CPU and the like that serves as the computer inside of the system control unit 120 executing a computer program that has been stored on a memory.

Note that the processing for steps S801, and S805 to S808 are the same as the processing for steps S301, and S305 to S308 in the First Embodiment, and therefore, explanations thereof will be omitted.

During step S802, the correction curve application necessity acquisition unit 206 determines whether or not to apply knee point automatic calculation based on a command from the user. That is, the correction curve application necessity acquisition unit 206 determines whether or not there has been a command from the user to apply knee point automatic calculations. In a case in which yes has been determined, the processing proceeds to step S803. In a case in which no has been determined, the processing proceeds to step S807.

During step S803, the knee correction parameter acquisition unit 202 receives the input (settings) of the maximum output level for the knee correction and the knee slope from the user.

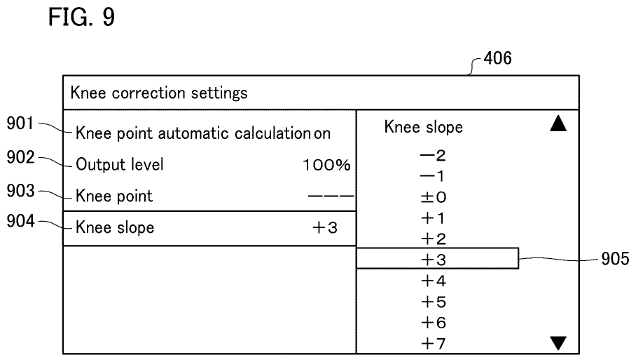

FIG. 9 is a diagram showing an example of a setting method for the knee slope according to the Second Embodiment, and shows an example of the knee correction parameter acquisition unit 202. The GUI screen 406 in FIG. 9 has a portion 901 that receives the on/off for the knee point automatic calculation, and a portion 902 that receives the output level (the maximum output level for the knee correction).

The GUI screen 406 further has a portion 903 that receives manual input (setting) of the knee point, and a portion 904 that receives the knee slope.

In FIG. 9, it becomes such that in a case in which the knee point automatic calculation has been applied, it is displayed that the portion 903 that receives the knee point cannot receive an input from the user. That is, in a case in which it has been determined during step S802 that the automatic calculation for the knee point will be applied to serve as the knee correction amount, the input from the user of the parameter for the knee point cannot be received.

Note that by aligning the cursor with each of the items on the left side of the GUI screen 406 and entering the menu, the parameter settings screen 905 is displayed on the right side of the GUI screen 406, and it is possible to receive the adjustment parameters from the user.

Using a GUI such as the GUI that is shown in FIG. 9, it is possible for the user to set the output level (maximum output level for the knee correction), and the knee slope, and then these settings are acquired during step S803.

During step S804, the knee correction amount calculating unit 203 calculates the value for the knee point from the output level (maximum output level for the knee correction) and the knee slope that have been received from the user. The knee point kp1 that occurs in the example in FIG. 5 can be calculated by finding the point of intersection of the knee curve 1 and the tone curve 501.

In the same manner, the knee point kp2 can be calculated by finding the point of intersection for the knee curve 2 and the tone curve 501. In this manner, by determining the parameter for the knee correction, it is possible to apply knee correction such that the maximum output level ymax that was set is reached at the maximum input level xmax without the user referring to the maximum input level xmax.

In addition, a point at which the line for the inclination for the knee slope that was set during step S904, which passes through a point that is determined from the maximum input point and the maximum output point for the tone curve, intersects with the low side of the output level from among the tone curve may also be made the knee point. In addition, at the knee point or greater, the knee curve (knee line) may be used, and a correction curve that uses the tone curve may be generated at less than the knee point.

In the manner that has been described above, according to the Present Embodiment, it is possible to adjust the parameters for the knee correction without the user considering the dynamic range for the input signal, and the output level.

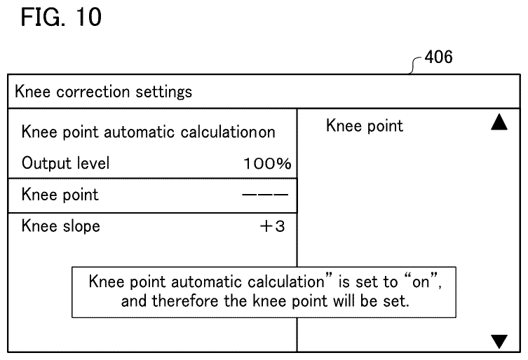

Note although in FIG. 9, an example has been explained of a display in which it has been made such that knee point settings cannot be received from the user in a case in which knee point automatic calculation will be applied, as is shown in FIG. 10, text such as “the knee point will be automatically set” and the like may also be displayed. As is shown in FIG. 10, it may also be displayed that “knee point automatic calculation is on”.

In this manner, in a case in which calculation of the knee correction amount by the correction amount calculating unit will be applied, it may also be made such that a message is displayed that shows that the knee point parameter will be automatically calculated.

While the disclosure has been described with reference to exemplary embodiments, it is to be understood that the disclosure is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the signal processing device and the like through a network or various storage media. Then, a computer (or a CPU, an MPU, and the like) of the signal processing device and the like may be configured to read and execute the program. In such a case, the program and the storage medium storing the program configure the disclosure.

In addition, the disclosure includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2024-047085, filed on Mar. 22, 2024, which is hereby incorporated by reference herein in its entirety.

What is claimed is:

1. A signal processing device comprising at least one processor or circuit configured to function as:
a storage unit configured to hold data for a tone curve to be applied to an input image;
a correction parameter acquisition unit configured to acquire a high-luminance side gradation correction parameter for adjusting a correction amount of a high-luminance side gradation correction for the tone curve
a correction amount calculating unit configured to calculate the correction amount for the high-luminance side gradation correction such that a dynamic range of the tone curve is maintained based on a maximum output level for the tone curve and the high-luminance side gradation correction parameter;
a correction curve generating unit configured to generate a correction curve by applying the high-luminance side gradation correction to the tone curve; and
a correction curve application unit configured to apply the correction curve to the input image.

2. The signal processing device according to claim 1, wherein the at least one processor or circuit is further configured to function as:
a determining unit configured to receive and determine whether or not to apply the high-luminance side gradation correction for the correction amount that was calculated by the correction amount calculating unit; wherein
in a case in which it has been determined by the determination unit that the high-luminance side gradation correction will be applied, the correction curve is applied to the input image.

3. The signal processing device according to claim 1, wherein the high-luminance side gradation correction parameter is a parameter for knee correction to be applied to the tone curve, and is one parameter from among a knee point at which the knee correction starts, and a knee slope.

4. The signal processing device according to claim 3, wherein the correction amount calculating unit calculates a knee correction amount such that a dynamic range of the tone curve is maintained based on the maximum output level and the knee correction parameter.

5. The signal processing device according to claim 4, wherein in a case in which the correction amount calculating unit will not apply the calculation of the knee correction amount by the correction amount calculation, the correction curve is generated according to parameters for the knee slope and the knee point that have been input by a user

6. The signal processing device according to claim 4, wherein in a case in which the correction amount calculating unit will not apply the calculation of the knee correction amount by the correction amount calculating unit, an input cannot be received from a user for one of the parameters of the knee slope and the knee point.

7. The signal processing device according to claim 6, wherein in a case in which the correction amount calculating unit will apply the calculation of the knee correction amount by the correction amount calculating unit, a message is displayed that shows that one of the parameters of the knee slope and the knee point will be automatically calculated.

8. A signal processing method comprising:
acquiring a maximum output level for a tone curve to be applied to an input image and a high-luminance side gradation correction parameter for adjusting a high-luminance side gradation correction level of the tone curve;
calculating a correction amount for high-luminance side gradation correction such that a dynamic range of the tone curve is maintained based on the maximum output level and the high-luminance side gradation correction parameter;
generating a correction curve by applying the high-luminance side gradation correction to the tone curve; and
applying the correction curve to the input image.

9. A non-transitory computer-readable storage medium configured to store a computer program comprising instructions for executing following processes:
acquiring a maximum output level for a tone curve to be applied to an input image and a high-luminance side gradation correction parameter for adjusting a high-luminance side gradation correction level of the tone curve;
calculating a correction amount for high-luminance side gradation correction such that a dynamic range of the tone curve is maintained based on the maximum output level and the high-luminance side gradation correction parameter;
generating a correction curve by applying the high-luminance side gradation correction to the tone curve; and
applying the correction curve to the input image.
